(19) United States
(12) Patent Application Publication
(10) Pub. No.: US 2025/0367931 A1
(43) Pub. Date: Dec. 4, 2025

(54) LIQUID DROPLET EJECTING HEAD

(71) Applicant: BROTHER KOGYO KABUSHIKI KAISHA, Nagoya (JP)

(72) Inventors: TAKAAKI YOSHINO, Nagoya (JP); MICHIHIRO SHIMADU, Toyota (JP); MASAYUKI SAITO, Nagoya (JP)

(73) Assignee: BROTHER KOGYO KABUSHIKI KAISHA, Nagoya (JP)

(21) Appl. No.: 19/195,974

(22) Filed: May 1, 2025

(30) Foreign Application Priority Data
May 31, 2024 (JP) 2024-088611

(51) Int. Cl. B41J 2/14

(52) U.S. Cl. CPC B41J 2/1433; B41J 2/14233; B41J 2002/14306; B41J 2002/14419; B41J 2002/14475

(57) ABSTRACT

A liquid droplet ejecting head includes: a pressure chamber disposed along a plane; a first nozzle which is open in a direction crossing the plane; a second nozzle which is open in the direction crossing the plane; a first connecting channel which connects the first nozzle and the pressure chamber; and a second connecting channel which connects the second nozzle and the pressure chamber. Each of the first connecting channel and the second connecting channel includes a first channel extending in a direction parallel to the plane and a second channel extending in the direction crossing the plane. Inertance of a part constructed of the first connecting channel and the first nozzle, and inertance of a part constructed of the second connecting channel and the second nozzle are different from each other.

### REFERENCE TO RELATED APPLICATIONS

This application claims priority from Japanese Patent Application No. 2024-088611 filed on May 31, 2024. The entire content of the priority application is incorporated herein by reference.

### BACKGROUND ART

There is a conventionally known liquid droplet ejecting apparatus having a configuration in which two nozzles communicate with one pressure chamber via, respectively, a first channel and a second channel. In this liquid droplet ejecting apparatus, in order to selectively eject liquid droplets from the two nozzles, the positions of openings in upstream ends, of the first channel and the second channel, connecting to the one pressure chamber are shifted in the longitudinal direction of the pressure chamber, thereby making the propagation time of the pressure wave different between the first channel and the second channel.

### SUMMARY

In the above-described liquid droplet ejecting apparatus, in order to realize the selective ejection of the liquid droplets, the positions of the openings of the upstream ends of the first channel and the second channel are shifted in the longitudinal direction of the pressure chamber. Therefore, since the length of the pressure chamber in the longitudinal direction is long, individual channels each including the pressure chamber cannot be disposed highly densely, and thus high resolution cannot be realized. Further, since the size of the pressure chamber is great, the natural frequency of each of the individual channels is small, and the high-speed recording cannot be realized as well.

An object of the present disclosure is to provide a liquid droplet ejecting head which can realize not only the selective ejection of the liquid droplets but also the high resolution and high-speed recording in the configuration wherein two nozzles communicate with one pressure chamber.

A liquid droplet ejecting head according to an aspect of the present disclosure includes: a pressure chamber disposed along a plane; a first nozzle which is open in a direction crossing the plane; a second nozzle which is open in the direction crossing the plane; a first connecting channel which connects the first nozzle and the pressure chamber; and a second connecting channel which connects the second nozzle and the pressure chamber; wherein each of the first connecting channel and the second connecting channel includes a first channel extending in a direction parallel to the plane and a second channel extending in the direction crossing the plane; and in a case where inertance of a part constructed of the first connecting channel and the first nozzle is M1 [kg/m⁴], and inertance of a part constructed of the second connecting channel and the second nozzle is M2 [kg/m⁴], the liquid droplet ejecting head satisfies the following expression (1): M1≠M2 . . . . Expression (1).

By satisfying the expression (1), the propagation time of the pressure wave can be made different between the first connecting channel and the second connecting channel. Consequently, the function of ejection speed with respect to the pulse width can be made different between the first and second connecting channels. Accordingly, by adjusting the pulse width, the selective ejection from the two nozzles can be realized. Further, in the present configuration, the size of the pressure chamber is not required to be increased for the purpose of realizing the selective ejection, and thus small pressure chambers can be densely disposed to realize the high resolution and the high-speed recording.

### BRIEF DESCRIPTION OF DRAWINGS

FIG. 1 is a plan view of a printer including a head according to a first embodiment of the present disclosure.

FIG. 2 is a block diagram depicting an electrical configuration of the printer.

FIG. 3 is a plan view of the head.

FIG. 4 is an enlarged view of an area IV in FIG. 3.

FIG. 5 is a cross-sectional view along a V-V line of FIG. 3.

FIG. 6 is a cross-sectional view along a VI-VI line of FIG. 3.

FIG. 7 is a graph depicting an example of a driving signal applied by a driver IC to a piezoelectric element.

FIG. 8 is a graph depicting a relationship between width of a main pulse of the driving signal and ejection speed of an ink droplet from each of two nozzles.

FIG. 9 is a graph depicting a relationship between inertance, primary frequency, and voltage ratio.

FIG. 10 depicts a head according to the second embodiment of the present disclosure, and is a cross-sectional view corresponding to FIG. 5.

FIG. 11 is an enlarged view of a head according to the third embodiment of the present disclosure, corresponding to FIG. 4.

FIG. 12A is a graph depicting a relationship between the width of the main pulse of the driving signal and the ejection speed of an ink droplet from each of the two nozzles, in an area above a curve L1 in FIG. 9; FIG. 12B is a graph depicting a relationship between the width of the main pulse of the driving signal and the ejection speed of the ink droplet from each of the two nozzles, in an area sandwiched between the curves L1 and L2 in FIG. 9; and FIG. 12C is a graph depicting a relationship between the width of the main pulse of the driving signal and the ejection speed of the ink droplet from each of the two nozzles, in an area below the curve L2 in FIG. 9.

FIG. 13 is a graph depicting a range satisfied by a head according to the fifth embodiment of the present disclosure in a graph similar to the graph of FIG. 9.

FIG. 14 is an enlarged view of a head of the sixth embodiment of the present disclosure, corresponding to FIG. 4.

### DESCRIPTION

### First Embodiment

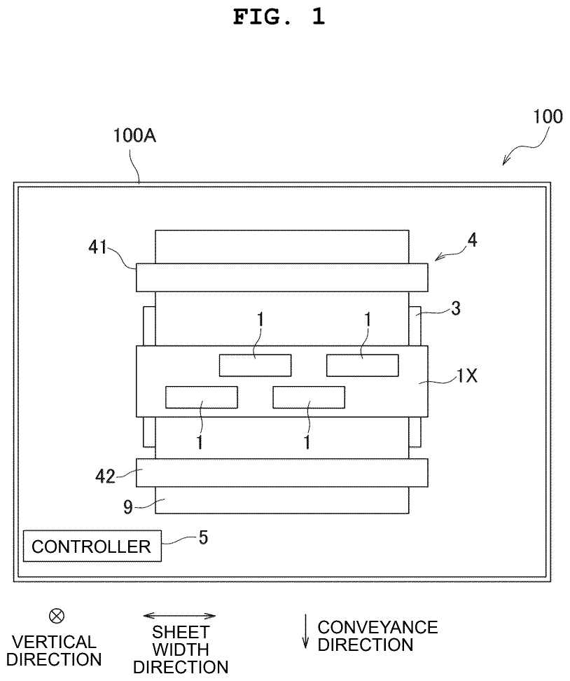

A head 1 depicted in FIG. 1 is the first embodiment of a liquid droplet ejecting head according to the present disclosure. The head 1 is included in a printer 100. The printer 100 includes a casing 100A, a head unit 1X including four heads 1, a platen 3, a conveyor 4, and a controller 5. The head unit 1X, the platen 3, the conveyor 4, and the controller 5 are disposed in the casing 100A.

The length of the head unit 1X in a sheet width direction is longer than the length of the head unit 1X in a conveyance direction. The head unit 1X is fixed to the casing 100A. The kind of system of the head unit 1X is the line system.

The sheet width direction is a direction along the width of a sheet 9 and is orthogonal to the vertical direction.

The four heads 1 included in the head unit 1X are disposed in a staggered manner in the sheet width direction. The length in the sheet width direction of each of the four heads 1 is longer than the length in the conveyance direction of each of the four heads 1.

The platen 3 is a plate along a plane orthogonal to the vertical direction, and is disposed below the head unit 1X. The sheet 9 is supported on the upper surface of the platen 3.

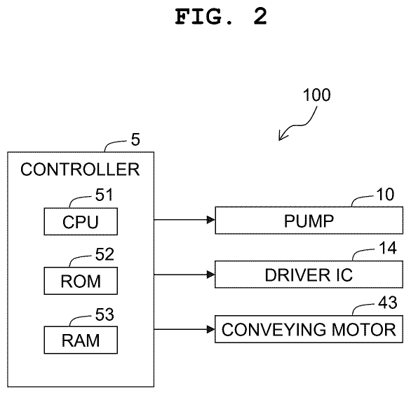

The conveyor 4 includes a roller pair 41 having two rollers, a roller pair 42 having two rollers, and a conveying motor 43 depicted in FIG. 2. In the conveyance direction, the head unit 1X and the platen 3 are disposed between the roller pair 41 and the roller pair 42. The conveyance direction is orthogonal to the vertical direction and the sheet width direction.

By the control of the controller 5, the rollers of the roller pairs 41 and 42 rotate. As the rollers of the roller pairs 41 and 42 rotate, the sheet 9 held by the rollers of the roller pairs 41 and 42 is conveyed in the conveyance direction.

As depicted in FIG. 2, the controller 5 includes a CPU 51, a ROM 52, and a RAM 53.

The CPU 51 executes a variety of kinds of control in accordance with a program and/or data stored in the ROM 52 and/or RAM 53, based on data input from an external device. The external device is, for example, a personal computer (PC).

The ROM 52 stores a program and data with which the CPU 51 performs the variety of kinds of control. The RAM 53 temporarily stores data to be used in a case where the CPU 51 executes the program.

Next, the configuration of head 1 will be described.

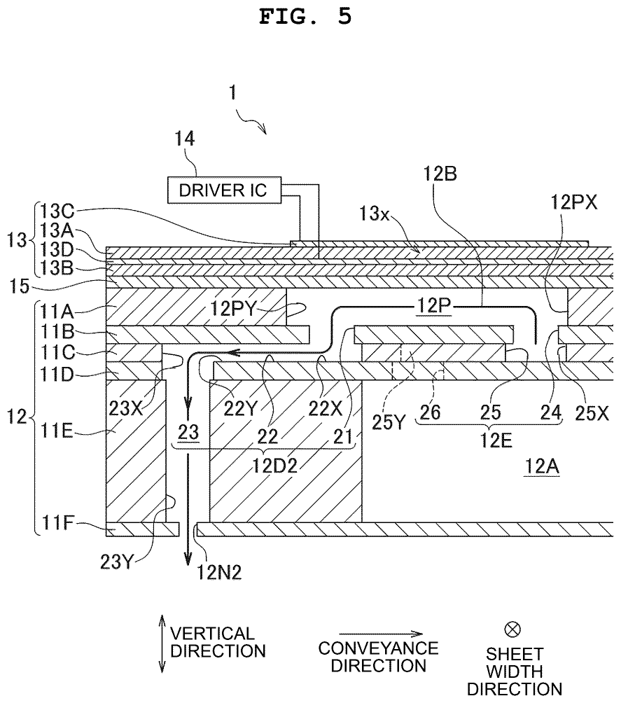

As depicted in FIG. 5, the head 1 includes a channel member 12, an actuator member 13, and a sealing member 15 disposed between the channel member 12 and the actuator member 13.

The channel member 12 has six plates 11A to 11F. The plates 11A to 11F are stacked in the vertical direction and adhered to one another. The plates 11A to 11F have holes formed therein and defining a channel. The channel includes a common channel 12A and a plurality of individual channels 12B.

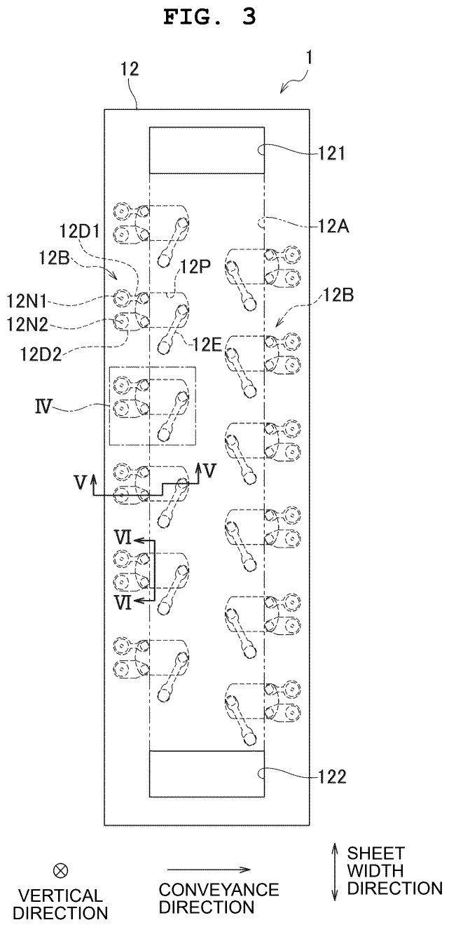

As depicted in FIG. 3, the common channel 12A extends in the sheet width direction. A supply port 121 is connected to one end in the sheet width direction of the common channel 12A. A return port 122 is connected to the other end in the sheet width direction of the common channel 12A. The supply port 121 and the return port 122 are open in the upper surface of the channel member 12. The upper surface of the channel member 12 is the upper surface of the plate 11A which is the uppermost layer of the six plates 11A to 11F. The supply port 121 and the return port 122 communicate with an ink tank via a tube. The common channel 12A communicates with the ink tank via the supply port 121 and the return port 122, and communicates also with the plurality of individual channels 12B.

The plurality of individual channels 12B are disposed in a staggered manner in the sheet width direction, as depicted in FIG. 3. Each of the plurality of individual channels 12B includes a pressure chamber 12P, two nozzles 12N1 and 12N2, a connecting channel 12D1 connecting the nozzle 12N1 and the pressure chamber 12P, a connecting channel 12D2 connecting the nozzle 12N2 and the pressure chamber 12P, and a communicating channel 12E allowing connecting the pressure chamber 12P and the common channel 12A to communicate with each other.

The nozzle 12N1 corresponds to a “first nozzle” of the present disclosure, and the nozzle 12N2 corresponds to a “second nozzle” of the present disclosure. The connecting channel 12D1 corresponds to a “first connecting channel” of the present disclosure and the connecting channel 12D2 corresponds to a “second connecting channel” of the present disclosure.

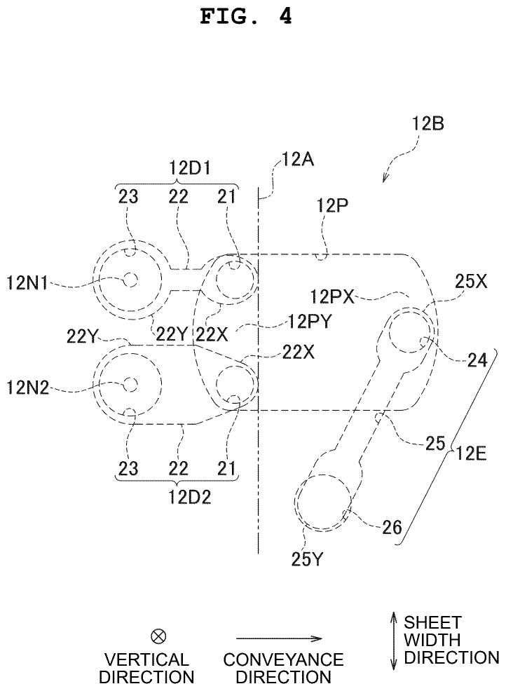

The pressure chamber 12P is disposed along the plane orthogonal to the vertical direction, as depicted in FIG. 4. This plane corresponds to a “plane” of present disclosure. The length in the conveyance direction of the pressure chamber 12P is longer than the length in the sheet width direction of the pressure chamber 12P. The pressure chamber 12P has one end 12PX, which is a downstream end in the conveyance direction, and the other end 12PY, which is an upstream end in the conveyance direction.

The plate 11A has a hole formed therein and defining the pressure chamber 12P, as depicted in FIG. 5. The pressure chamber 12 is open in the upper surface of the channel member 12.

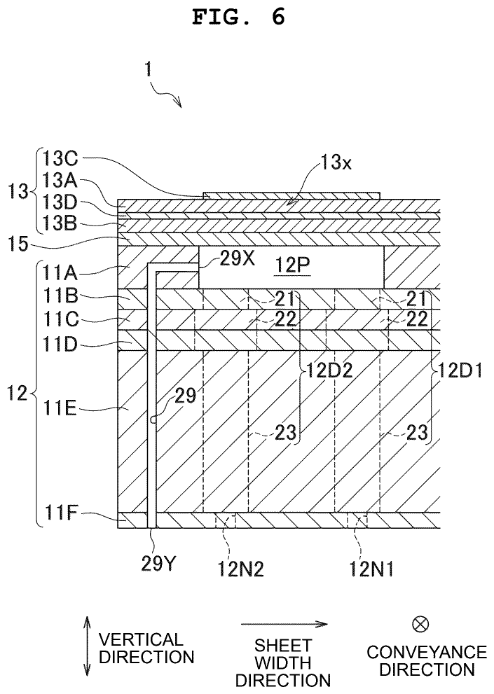

The channel member 12 has a hole 29 formed therein and having one end 29X communicating with the pressure chamber 12P and the other end 29Y communicating with the atmosphere, as depicted in FIG. 6. The hole 29 is formed through the plates 11A to 11F, and the other end 29Y of the hole 29 is open in the lower surface of the plate 11F. A meniscus absorbing pressure variation of the ink in the pressure chamber 12P is formed in the other end 29Y of the hole 29. The hole 29 has a small channel cross-sectional area, a long channel length and a high channel resistance. Accordingly, the ink does not leak from the other end 29Y of the hole 29 during the ejection of the ink from the nozzle 12N1 or 12N2 by driving of the piezoelectric element 13X, as will be described later.

The connecting channel 12D1 is configured to connect the nozzle 12N1 to the other end 12PY of the pressure chamber 12P, and the connecting channel 12D2 is configured to connect the nozzle 12N2 to the other end 12PY of the pressure chamber 12P, as depicted in FIGS. 4 and 5. Each of the connecting channels 12D1 and 12D2 includes a vertical hole 21, a horizontal channel 22, and a vertical channel 23.

Although FIG. 5 depicts the cross-section passing through the connecting channel 12D2 and the nozzle 12N2, the cross-section passing through the connecting channel 12D1 and nozzle 12N1 has a similar configuration.

As depicted in FIG. 5, the plate 11B has the vertical hole 21 formed therein and extending downward from the other end 12PY of the pressure chamber 12P.

As depicted in FIG. 5, the plate 11C has a hole formed therein, extending in the conveyance direction and defining the horizontal channel 22. The horizontal channel 22 corresponds to a “first channel” of the present disclosure. The conveyance direction is parallel to the plane in which the pressure chamber 12P is disposed, and corresponds to an “extending direction” of the present disclosure. The horizontal channel 22 has one end 22X which is a downstream end in the conveyance direction, and the other end 22Y which is an upstream end in the conveyance direction. The one end 22X is connected to the vertical hole 21, and the other end 22Y is connected to the vertical channel 23. The one end 22X is connected to the pressure chamber 12P via the vertical hole 21.

As depicted in FIG. 5, the plates 11D and 11E have, respectively, holes formed therein and extending in the vertical direction, and the vertical channel 23 is constructed of these holes. The vertical channel 23 corresponds to a “second channel” of the present disclosure. The vertical direction is a direction crossing with the plane in which the pressure chamber 12P is disposed. The vertical channel 23 has one end 23X in the vertical direction which is an upper end, and the other end 23Y in the vertical direction which is a lower end. The one end 23X is connected to the horizontal channel 22, and the other end 23Y is connected to the nozzle 12N1 or the nozzle 12N2.

The plate 11F has a hole which is formed therein and which is open in the lower surface of the plate 11, and each of the nozzles 12N1 and 12N2 is constructed of this hole. The lower surface of the plate 11F is the lower surface of the channel member 12. The nozzles 12N1 and 12N2 are open downward, i.e., in a direction crossing the plane in which the pressure chamber 12P is disposed.

As depicted in FIGS. 4 and 5, the communicating channel 12E connects the common channel 12A and the one end 12PX of the pressure chamber 12P, and includes a vertical hole 24, a horizontal channel 25, and a vertical hole 26.

As depicted in FIG. 5, the plate 11B has a vertical hole 24 formed therein and extending downward from one end 12PX of the pressure chamber 12P.

The plate 11C has a hole formed therein and defining the horizontal channel 25, as depicted in FIG. 5. The horizontal channel 25 extends along the plane orthogonal to the vertical direction, i.e., along the plane in which the pressure chamber 12P is disposed, in a direction crossing both the conveyance direction and the sheet width direction, as depicted in FIG. 4. The horizontal channel 25 corresponds to a “third channel” of the present disclosure. The horizontal channel 25 has one end 25X and the other end 25Y. The one end 25X is connected to the vertical hole 24, and the other end 25Y is connected to the vertical hole 26. The one end 25X is connected to the pressure chamber 12P via the vertical hole 24, and the other end 25Y is connected to the common channel 12A via the vertical hole 26.

As depicted in FIG. 5, the plate 11C has both the hole which defines the horizontal channel 22 and the hole which defines the horizontal channel 25. The horizontal channel 22 and the horizontal channel 25 are each disposed throughout the entire thickness of the plate 11C.

As depicted in FIG. 5, the plate 11D has the vertical hole 26 formed therein and extending upward from the upper surface of the common channel 12A.

In a case where the pump 10 depicted in FIG. 2 is driven under the control of the controller 5, the ink in the ink tank is thereby supplied to the common channel 12A via the supply port 121, and is then distributed from the common channel 12A to the plurality of individual channels 12B (see FIG. 3).

In a case where a piezoelectric element 13X which will be described later is driven and the volume of the pressure chamber 12P is thereby decreased, pressure is applied to the ink in the pressure chamber 12P. The ink to which pressure is applied passes through the connecting channel 12D1 and/or the connecting channel 12D2 and is ejected as an ink droplet from the nozzle 12N1 and/or the nozzle 12N2.

The ink which is supplied to the common channel 12A via the supply port 121 but is not distributed to the individual channels 12B returns to the ink tank via the return port 122.

As depicted in FIG. 5, the sealing member 15 is disposed on the upper surface of the channel member 12 so as to cover a plurality of pressure chambers 12P. The sealing member 15 is made, for example, of a material with low ink permeability, such as stainless steel, etc.

As depicted in FIG. 5, the actuator member 13 is fixed to the upper surface of the channel member 12 via the sealing member 15. The actuator member 13 includes a piezoelectric layer 13A, a piezoelectric layer 13B, and a plurality of individual electrodes 13C. The piezoelectric layers 13A and 13B and the common electrode 13D are disposed to cover the plurality of pressure chambers 12P. Each of the plurality of individual electrodes 13C is disposed with respect to one pressure chamber 12 included in the plurality of pressure chambers 12P and corresponding thereto; each of the plurality of individual electrodes 13C is disposed to overlap the one pressure chamber 12P in the vertical direction.

A part, of the actuator member 13, which overlaps with the pressure chamber 12P in the vertical direction functions as a piezoelectric element 13X. The piezoelectric element 13 is disposed as a plurality of piezoelectric elements 13X which are independently deformable according to the potential applied thereto. Each of the piezoelectric elements 13X is a bulk piezoelectric element, rather than a thin film piezoelectric element. The thin film piezoelectric element is an extremely small device, a so-called micro electro mechanical systems (MEMS), in which a plurality of piezoelectric elements is integrated by sequentially depositing thin films such as an electrode film and a piezoelectric film on a substrate. The bulk piezoelectric element is a piezoelectric element in which a plurality of piezoelectric sheets obtained by sintering are stacked.

The plurality of individual electrodes 13C and the common electrode 13D are electrically connected to the driver IC 14. The driver IC 14 changes the potential of each of the plurality of individual electrodes 13C, while maintaining the potential of the common electrode 13D at the ground potential. The common electrode 13D is an electrode common to the plurality of piezoelectric elements 13X.

The driver IC 14 generates a driving signal based on a control signal from the controller 5, and supplies the driving signal to each of the plurality of individual electrodes 13C. The driving signal changes the potential of each of the plurality of individual electrodes 13C between a predetermined driving potential VDD and the ground potential.

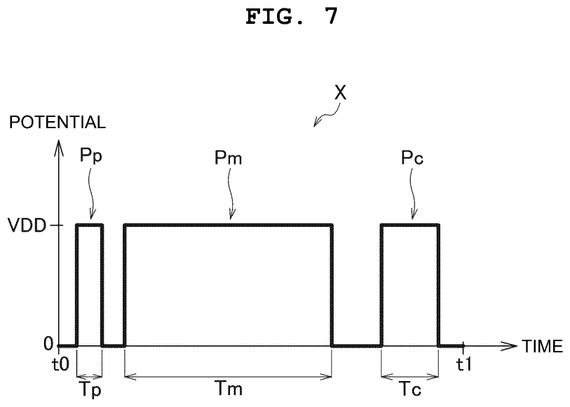

An example of a driving signal is depicted in FIG. 7.

A driving signal X depicted in FIG. 7 includes three rectangular pulses in one ejecting cycle (time from time t0 to time t1) for forming one dot. The three pulses include a main pulse Pm, a pre-pulse Pp applied before the main pulse Pm, and a cancel pulse Pc applied after the main pulse Pm.

The main pulse Pm is a pulse to eject an ink droplet of a predetermined volume from each of the nozzles 12N1 and 12N2. Each of the pre-pulse Pp and the cancel pulse Pc is a pulse to reduce the generation of a satellite droplet, and the pre-pulse Pp and the cancel pulse Pc have, respectively, width Tp and width Tc each smaller than width Tm of the main pulse Pm. The satellite droplet is generated in a case where the tail of an ink droplet separates from the main droplet of the ink droplet, and the volume of the satellite droplet is smaller than the volume of the main droplet. The pre-pulse Pp cancels the pressure wave, in the pressure chamber 12P, generated in a previous ejecting cycle before a certain ejecting cycle. The cancel pulse Pc cancels the pressure wave, in the pressure chamber 12P, generated by the application of the main pulse Pm in the certain ejecting cycle.

By adjusting the width Tm of the main pulse Pm, an ink droplet can be selectively ejected from one of the two nozzles 12N1 and 12N2, from the other of the two nozzles 12N1 and 12N2, or from both the two nozzles 12N1 and 12N2. The inventors of the present disclosure have found that making inertance M1 [kg/m⁴] of a part constructed of the connecting channel 12D1 and the nozzle 12N1 and inertance M2 [kg/m⁴] of a part constructed of the connecting channel 12D2 and the nozzle 12N2 different from each other is effective in realizing the selective ejection and also in realizing the high resolution and the high-speed recording.

That is, the head 1 satisfies the following expression (1).

M1≠M2 Expression (1)

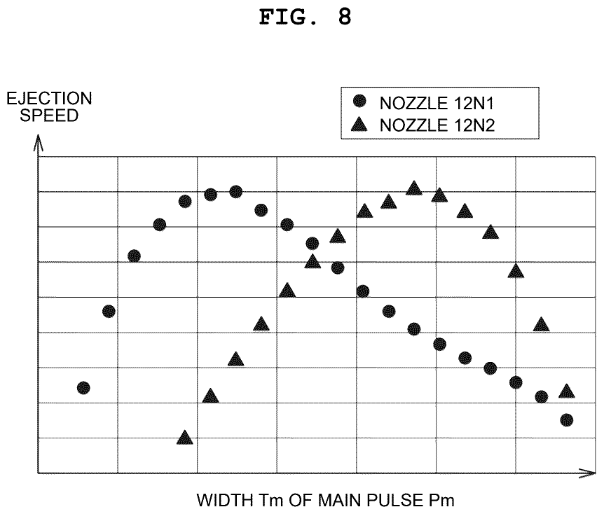

By satisfying the expression (1), the propagation time of the pressure wave can be made different between the connecting channels 12D1 and 12D2, and consequently, the function of the ejection speed with respect to the width Tm (see FIG. 8) can be made different between the connecting channels 12D1 and 12D2. With this, the selective ejection from the two nozzles 12N1 and 12N2 can be realized by adjusting the width Tm. Further, in the present configuration, since the size of the pressure chamber 12P needs not to be increased for the purpose of realizing the selective ejection, small pressure chambers 12P can be disposed at high density to thereby realize the high resolution and the high-speed recording.

In the present embodiment, inertance M1a [kg/m⁴] of the horizontal channel 22 of the connecting channel 12D1 and inertance M2a [kg/m⁴] of the horizontal channel 22 of the connecting channel 12D2 are made different from each other. That is, the head 1 further satisfies the following expression (2).

M1a≠M2a Expression (2)

By configuring the head 1 so as to satisfy the expression (2), the expression (1) can be easily satisfied.

Specifically, as depicted in FIG. 4, the channel width of a part, of the horizontal channel 22 of the connecting channel 12D1, other than the one end 22X and the other end 22Y is smaller than the channel width of a part, of the horizontal channel 22 of the connecting channel 12D2, other than the one end 22X and the other end 22Y. The channel width is a length in the sheet width direction. The cross-sectional area of the horizontal channel 22 of the connecting channel 12D1 is smaller than the cross-sectional area of the horizontal channel 22 of the connecting channel 12D2. The inertance of the flow channel is expressed as ρL/S [kg/m⁴], wherein S [m²] is the cross-sectional area of the flow channel, L [m] is the length of the channel, and ρ [kg/m³] is the density of the ink in the channel. The channel length of the horizontal channel 22 of the connecting channel 12D1 and the channel length of the horizontal channel 22 of the connecting channel 12D2 are approximately the same. Therefore, in the present embodiment, M1a>M2a holds.

The head 1 further satisfies the following expression (3) and expression (4).

M1c≤M1n Expression (3)

M2c≤M2n Expression (4)

Here, M1c is inertance [kg/m⁴] of the connecting channel 12D1, M1n is inertance [kg/m⁴] of the nozzle 12N1, M2c is inertance [kg/m⁴] of the connecting channel 12D2, and M2n is inertance [kg/m⁴] of the nozzle 12N2. In a case where the inertance of the connecting channel 12D1 is greater than the inertance of the nozzles 12N1 and where the inertance of the connecting channel 12D2 is greater than the inertance of the nozzle 12N2, the pressure wave is likely to be reflected by the connecting channels 12D1 and 12D2. In this case, in order to cause the pressure wave to propagate to the nozzles 12N1 and 12N2, the driving voltage applied to the piezoelectric element 13X needs to be increased. In this regard, since the present configuration satisfies the expression (3) and the expression (4), the pressure wave is unlikely to be reflected by the connecting channels 12D1 and 12D2, and the driving voltage applied to the piezoelectric element 13X can be made low.

Further, the inventors of the present disclosure have found that causing the head 1 to satisfy the following expression (5), expression (6), and expression (7) is effective in making the driving voltage to be applied to the piezoelectric element 13X low.

F1=F2 Expression(5)

M1≥2.99×10⁴×F1\hat{ }2−1.11×10⁷×F1+1.06×10⁹ Expression (6)

M2≤6.11×10¹×F2\hat{ }3−2.41×10⁴×F2\hat{ }2+1.86×10⁶×F2+1.10×10⁸ Expression (7)

Here, F1 is the primary frequency [kHz] of the connecting channel 12D1, and F2 is the primary frequency [kHz] of the connecting channel 12D2. The primary frequency F1 and the primary frequency F2 are mainly governed by the configuration of the communicating channel 12E, but may also be influenced by the configurations of the connecting channels 12D1 and 12D2, the nozzles 12N1 and 12N2, by the presence or absence of a damper, etc.

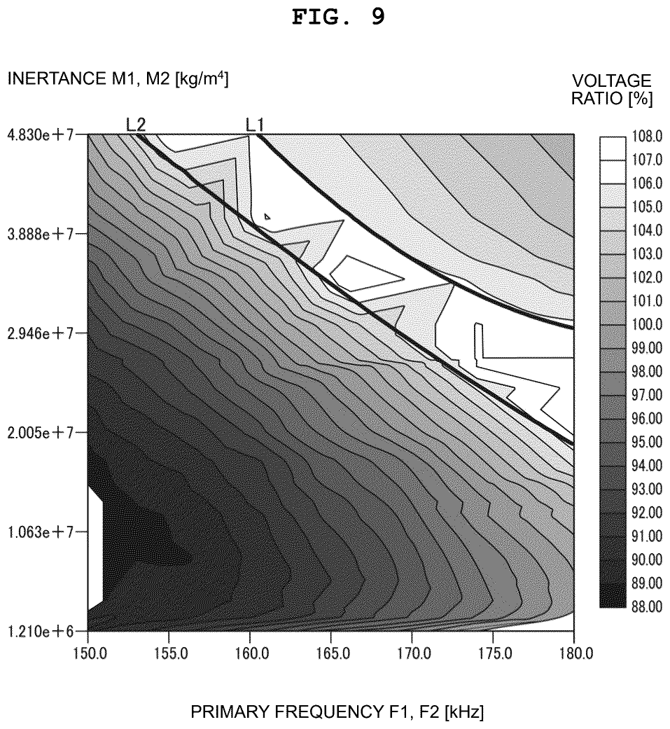

FIG. 9 depicts the result of analysis conducted by the inventors of the present disclosure. As appreciated from FIG. 9, a correlation is present among the inertance M1 and the inertance M2, the primary frequency F1 and the primary frequency F2, and the voltage ratio. The voltage ratio is the ratio in a case where the viscosity of the ink is 7 cps, the surface tension of the ink is 24 mN/m, the configuration, in each of the individual channels 12B, other than the connecting channel is a predetermined configuration, and the driving voltage when the ejection speed becomes a predetermined speed (for example, 7 m/s) is set to “1”.

In FIG. 9, each of a curve L1 and a curve L2 is a curved line along the voltage ratio of 104%. The curve L1 approximates to the Expression: “2.99×10⁴×F1\hat{ }2−1.11×10⁷×F1+1.06×10⁹”, and curve L2 approximates to the Expression: “6.11×10¹×F2\hat{ }3−2.41×10⁴×F2\hat{ }2+1.86×10⁶×F2+1.10×10⁸”.

An area above the curve L1 is an area in which the voltage ratio is 104% or less, and is defined by the expression (6). An area below the curve L2 is an area in which the voltage ratio is 104% or less, and is defined by the expression (7). In a case where the expressions (5), (6), and (7) are satisfied, the voltage ratio is 104% or less, and the driving voltage applied to piezoelectric element 13X can be made low.

The head 1 has the hole 29 having the one end 29X communicating with the pressure chamber 12P and the other end 29Y communicating with the atmosphere, and the meniscus configured to absorb the pressure variation of the ink in the pressure chamber 12P is formed at the other end 29Y of the hole 29 (see FIG. 6). In a case where the two nozzles 12N1 and 12N2 communicate with one pressure chamber 12P as in the present embodiment, the high-frequency component of the pressure wave generated in the connecting channel 12D1 and the connecting channel 12D2 and which are reflected by the nozzles 12N1 and 12N2 and return to the pressure chamber 12P are twice as many as in the case of a configuration in which one nozzle communicates with one pressure chamber 12P. In this case, in the pressure chamber 12P, the waveform of the pressure wave becomes complicated by the returned high-frequency component added to the pressure wave caused by driving of the piezoelectric element 13X, and a satellite droplet might be generated. In this regard, in the present configuration, the pressure variation in the pressure chamber 12P is absorbed by the hole 29, and thus the high frequency component is reduced and the generation of the satellite droplet can be reduced.

The one plate 11C has both the hole which defines the horizontal channel 22 and the hole which defines the horizontal channel 25 (see FIG. 5). In a case where the horizontal channels 22 and 25 are disposed, respectively, in separate plates, the horizontal channel 22 and the horizontal channel 25 are formed in separate steps. In this case, the variation in dimension between the horizontal channel 22 and the horizontal channel 25 is great due to the overlap of the variation in dimension which occurs in the respective steps, and a desired pressure wave cannot be propagated to the nozzles 12N1 and 12N2. In this regard, in the present configuration, the horizontal channel 22 and the horizontal channel 25 are disposed in the same plate 11C, and thus the horizontal channel 22 and the horizontal channel 25 can be formed in the same step. In this case, the above-mentioned overlap of the variation in dimension does not occur, and the variation in dimension between horizontal channels 22 and 25 can be reduced. This consequently allows the desired pressure wave to be propagated to the nozzles 12N1 and 12N2.

The horizontal channels 22 and 25 are disposed over the entire thickness of the plate 11C. In this case, the length in the vertical direction of the horizontal channels 22 and 25 can be made constant, as compared to the case where the horizontal channels 22 and 25 are disposed over a part of the thickness of the plate 11C by half-etching, etc. With this, consequently, the size of each of the horizontal channels 22 and 25 can be made as designed.

The position in the conveyance direction of the other end 22Y of the horizontal channel 22 in the connecting channel 12D1 coincides with the position in the conveyance direction of the other end 22Y of the horizontal channel 22 in the connecting channel 12D2 (see FIG. 4). In this case, the length in the extending direction (in this embodiment, the longitudinal direction of the pressure chamber) in the entirety of the individual channel including the connecting channel can be made small. With this, the individual channels can be disposed highly densely and thus the high resolution can be realized as well.

### Second Embodiment

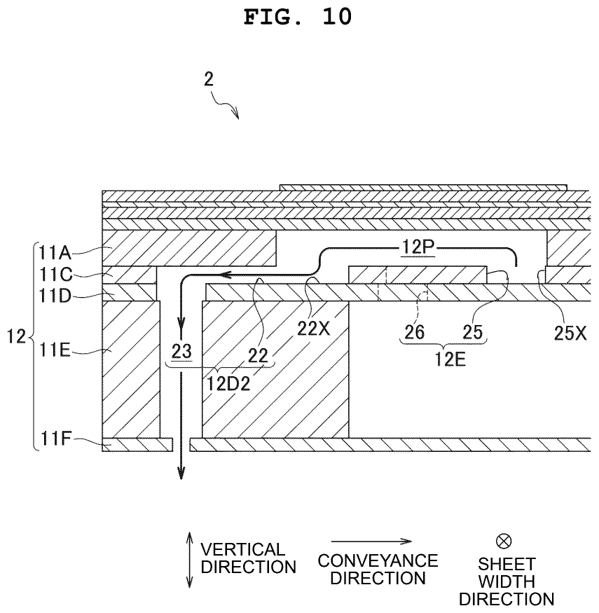

A head 2 depicted in FIG. 10 is the second embodiment of the liquid droplet ejecting head according to the present disclosure. The head 2 differs from the head 1 of the first embodiment in that the channel member 12 has the five plates which are the plates 11A and 11C to 11F, namely, the plate 11B of the first embodiment is omitted.

Each of the connecting channel 12D1 and the connecting channel 12D2 of the present embodiment includes the horizontal channel 22 and the vertical channel 23, and does not include the vertical hole 21 (see FIG. 5) of the first embodiment. One end 22X of the horizontal channel 22 is connected to the pressure chamber 12P, not via the vertical hole 21. Similarly, the communicating channel 12E of the present embodiment includes the horizontal channel 25 and the vertical hole 26, and does not include the vertical hole 24 (see FIG. 5) of the first embodiment. One end 25X of the horizontal channel 25 is connected to the pressure chamber 12P, not via the vertical hole 24.

In a case where the expression (2) as described above is satisfied, one of the two connecting channels 12D1 and 12D2 has a large inertance in the horizontal channel 22. In this case, by directly connecting the horizontal channel 22 having a large inertance to the pressure chamber 12P, the high frequency component of the pressure wave can be reduced and the generation of satellite droplet can be reduced.

Further, in the present embodiment, the plate 11B is omitted and the number of components of the head 2 is small, and thus the structure of the head 2 is simplified and the head 2 can be manufactured easily.

### Third Embodiment

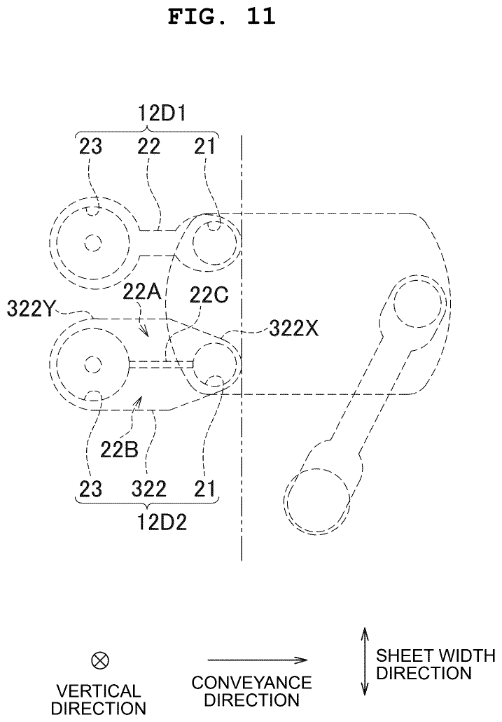

A head according to the third embodiment of the present disclosure will be described, with reference to FIG. 11. The head of the present embodiment differs from the head 1 of the first embodiment (see FIG. 4) in the configuration of a horizontal channel 322 in the connecting channel 12D2.

As depicted in FIG. 11, the horizontal channel 322 includes two channel parts 22A and 22B. The two channel parts 22A and 22B are disposed side by side in the sheet width direction and extend in the conveyance direction. The two channel parts 22A and 22B share one end 322X and the other end 322Y of the horizontal channel 322.

A partition wall 22C is disposed within the horizontal channel 322. The partition wall 22C extends in the conveyance direction in an area between the one end 322X and the other end 322Y of the horizontal channel 322, and divides the area into two areas. The two divided areas construct, respectively, the channel part 22A and the channel part 22B. The partition wall 22C is interposed between the two channel parts 22A and 22B.

The resistance of the horizontal channel 22 of the connecting channel 12D1 and the synthetic resistance of the two channel parts 22A and 22B of the connecting channel 12D2 are the same.

Such a configuration is conceivable that the channel cross-sectional area of the horizontal channel 22 is made different between the connecting channel 12D1 and the connecting channel 12D2 to thereby satisfy the expression (2) as described above. However, in this case, during the initial introduction and/or the purging, the ink is less likely to flow through one horizontal channel 22, of the two horizontal channels 22, which has a small channel cross-sectional area, and thus the air cannot be exhausted easily through the one horizontal channel 22 having the small channel cross-sectional area. In this regard, in the present configuration, even in a case where the channel cross-sectional area of the horizontal channel 22 is made different between the connecting channel 12D1 and the connecting channel 12D2, the resistances of the two horizontal channels 22 are the same. Therefore, a sufficient amount of ink flows through both of the two horizontal channels 22 during the initial introduction and/or the purging, thereby causing the air to be easily exhausted through both of the two horizontal channels 22.

Note that the term “initial introduction” refers to introducing the ink from the ink tank into the channel in the head. The term “purging (purge)” refers to forcibly causing the ink to be discharged from the nozzle by driving the pump.

Further, owing to the presence the partition wall 22C, the two channel parts 22A and 22B can be easily formed.

### Fourth Embodiment

A head according to the fourth embodiment of the present disclosure satisfies the following expressions (8), (9), and (10), rather than satisfying the expressions (5), (6), and (7).

F1≠F2 Expression (8)

M1<2.99×10⁴×F1\hat{ }2−1.11×10⁷×F1+1.06×10⁹ Expression (9)

M2>6.11×10¹×F2\hat{ }3−2.41×10⁴×F2\hat{ }2+1.86×10⁶×F2+1.10×10⁸ Expression (10)

In a case where the expression (8) is not satisfied, the range, of each of M1 and M2, corresponding to the desired driving voltage is narrow, and M1˜ M2 is likely to hold. Specifically, in FIG. 9, in order that a horizontal axis F1 and a horizontal axis F2 have the same value and that the voltage ratio is set to 104% or more, the range which the vertical axis M1 and the vertical axis M2 can take is narrow. For example, in order to realize the voltage ratio of 104% or more in a case where F1=F2=170 kHz holds, M1 and M2 need to be in the range of approximately 2.9×10⁷ kg/m⁴ to approximately 3.6×10⁷ kg/m⁴. In a case where the values of M1 and M2 approximate to each other, the function of ejection speed with respect to the pulse width (see FIG. 8) takes a similar value in the connecting channel 12D1 and the connecting channel 12D2, and thus the selective ejection is less likely to be realized. In this regard, according to the present configuration, by satisfying the expression (8), the range which M1 and M2 can take can be widened, and the occurrence of such a situation that the values of M1 and M2 approximate to each other can be reduced. With this, the selective ejection can be realized in a more ensured manner.

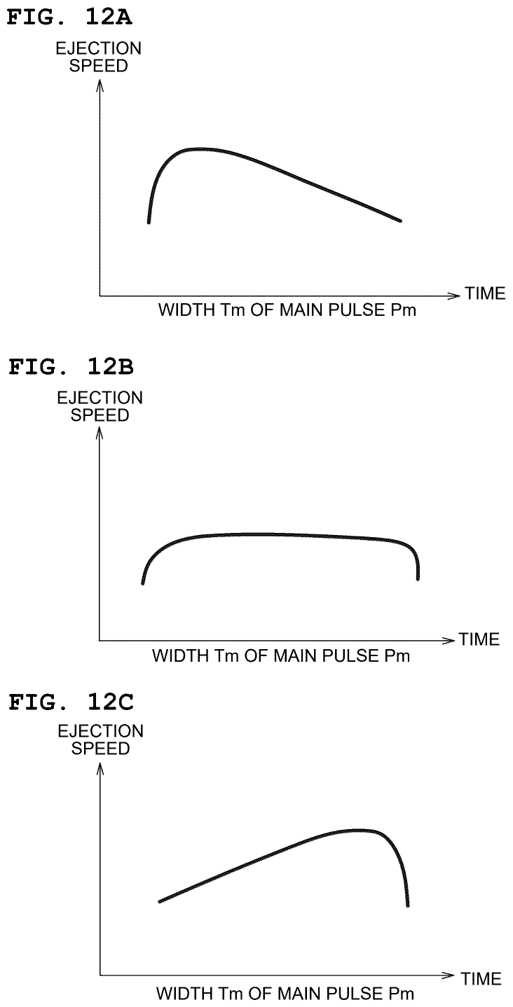

In a case where the expression (9) and the expression (10) are satisfied, the area in this case corresponds to an area between curve L1 and curve L2 in FIG. 9, and the voltage ratio exceeds 104%. In this case, the driving voltage applied to the piezoelectric element 13X is high. The inventors of the present disclosure have found that the driving voltage affects the function of the ejection speed with respect to the pulse width. Specifically, in the area above the curve L1 in FIG. 9, the ejection speed changes with respect to the pulse width as depicted in FIG. 12A. In the area between the curves L1 and L2 in FIG. 9, the ejection speed changes with respect to the pulse width as depicted in FIG. 12B. In the area below the curve L2 in FIG. 9, the ejection speed changes with respect to the pulse width as depicted in FIG. 12C. In other words, in a case where the expression (9) and the expression (10) are satisfied, the ejection speed changes slowly with respect to the pulse width as depicted in FIG. 12B. Therefore, in a plurality of driving signals having different pulse widths, the ejection speed is less likely to vary. Further, even in a case where the pulse width is made different among the case where an ink droplet is ejected from one of the two nozzles 12N1 and 12N2, the case where an ink droplet is ejected from the other of the two nozzles 12N1 and 12N2, and the case where an ink droplet is ejected from both the one and the other of the two nozzles 12N1 and 12N2, the ejection speed is less likely to vary.

### Fifth Embodiment

A head according to the fifth embodiment of the present disclosure satisfies the following expression (8), expression (11), and expression (12), rather than satisfying the expression (5), the expression (6), and the expression (7). The expression (8) is the same as the expression (8) in the fourth embodiment.

F1≠F2 Expression (8)

M1≤−1.23×10⁶×F1+2.32×10⁸ Expression (11)

M2≤−1.23×10⁶×F2+2.32×10⁸ Expression (12)

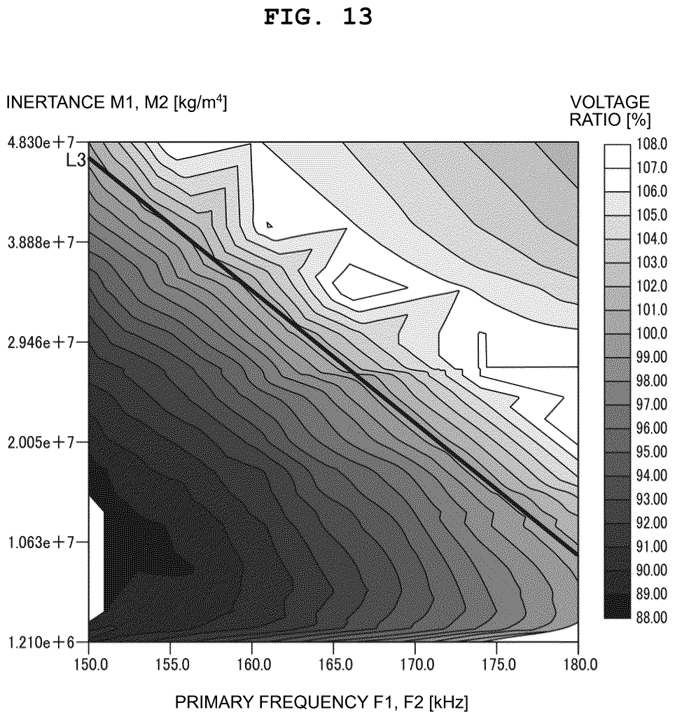

In a case where the expressions (11) and (12) are satisfied, the area in this case corresponds to an area below a line L3 in FIG. 13, and the voltage ratio is approximately 101% or less. In this case, the driving voltage applied to the piezoelectric element 13X can be made low.

Further, in the present embodiment, in a case where F1>F2 and M1>M2 holds, the following expression (13) is further satisfied.

M1−M2=−1.23×10⁶×(F1−F2) Expression (13)

In a case where the expression (13) is satisfied, the peak value of the ejection speed of the ink droplet from one of the two nozzles 12N1 and 12N2 can be made equal to the peak value of the ejection speed of the ink droplet from the other of the two nozzles 12N1 and 12N2. With this, the occurrence of any deviation in the landing of liquid droplets, which might occur in a case where the peak values are different, can be reduced.

### Sixth Embodiment

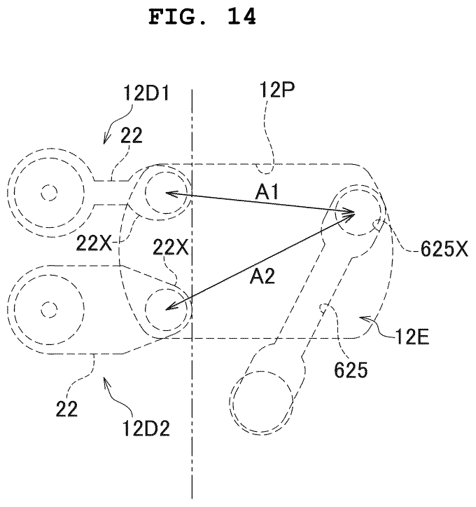

A head according to the sixth embodiment of the present disclosure will be described, with reference to FIG. 14. The head of the present embodiment differs from the head of the first embodiment (see FIG. 4), in the configuration of a horizontal channel 625 in the communicating channel 12E.

As depicted in FIG. 14, one end 625X of the horizontal channel 625 is located in the vicinity of one end in the sheet width direction of the pressure chamber 12P, rather than in the center in the sheet width direction of the pressure chamber 12P. As a result, a distance A1 between the one end 22X of the horizontal channel 22 of the connecting channel 12D1 and one end 625X of the horizontal channel 625 of the communicating channel 12E is smaller than a distance A2 between the one end 22X of the horizontal channel 22 of the connecting channel 12D2 and the one end 625X of the horizontal channel 625 of the communicating channel 12E (A1<A2). Each of the distance A1 and the distance A2 is a distance along the plane in which the pressure chamber 12P is disposed.

The configuration of the present embodiment is effective in a case where M1a>M2a holds. In a case where M1a>M2a holds, in the configuration of the first embodiment (see FIG. 4), the ink does not easily flow into the horizontal channel 22 of the connecting channel 12D1 during the initial introduction and/or the purging, and the air is not easily exhausted through the connecting channel 12D1. In this regard, in the present configuration, A1<A2 holds and thus the ink easily flows from the horizontal channel 625 through the pressure chamber 12P into the horizontal channel 22 of the connecting channel 12D1. Therefore, the ink easily flows into the horizontal channel 22 of the connecting channel 12D1 also during the initial introduction and/or the purging, and the air can be exhausted through both the connecting channels 12D1 and 12D1.

### (Modification)

In the foregoing, although the embodiments of the present disclosure have been described, the present disclosure is not limited to the above-described embodiments, and various design changes are possible within the scope of the claims.

For example, in the above-described embodiments, the other end 29Y of the hole 29 (see FIG. 6) is open in the lower surface of the channel member 12. However, the present disclosure is not limited to this. For example, the other end 29Y may be open in a side surface or the upper surface of the channel member 12.

In the above-described embodiments, although the electrode constructing the piezoelectric element has a two-layered structure including the individual electrode and the common electrode, the electrode may have a three-layered structure. The term “three-layered structure” means, for example, a structure including a driving electrode to which a high potential and a low potential are selectively applied, a high potential electrode maintained at the high potential and a low potential electrode maintained at the low potential.

The piezoelectric element may be a thin film piezoelectric element.

In the third embodiment (see FIG. 11), although the two channel parts 22A and 22B are disposed side by side in the sheet width direction, the present disclosure is not limited to this. The two channel parts 22A and 22B may be disposed side by side, for example, in the vertical direction. Further, in the third embodiment (see FIG. 11), although the partition wall 22C is disposed, such a configuration is also allowable in which the partition wall 22C is omitted, and which includes a channel part constructed of a horizontal channel 22 similar to the horizontal channel 22 of the first embodiment, and another channel part sharing the other end 22Y of the horizontal channel 22 with the channel part and extending from the other end 22Y to the pressure chamber 12P.

The extending direction, as the direction in which the first channel extends, is the longitudinal direction of the pressure chamber in the above-described embodiments. However, the present disclosure is not limited to this. For example, the extending direction may be a direction which crosses both the conveyance direction and the sheet width direction in the above-described embodiments.

The positional relationship between the first channel and the second channel is not limited to the positional relationship as described above. For example, the positional relationship in the vertical direction between the horizontal channel 22 and the vertical channel 23 may be the opposite of the positional relationship in the above-described embodiments. In this case, the horizontal channel 22 is connected to the nozzle 12N1 or the nozzle 12N2, and the vertical channel 23 is connected to the other end 12PY of the pressure chamber 12P.

The kind of the system of the liquid droplet ejecting head is not limited to the line system, but may be a serial system.

The object to which the liquid droplet is ejected is not limited to the sheet, and may be, for example, a cloth, a substrate, or a plastic member.

The liquid droplet ejected from the nozzle is not limited to the ink droplet. For example, the liquid droplet may be, for example, a liquid droplet of a treatment liquid which agglutinates or precipitates a component in the ink.

The present disclosure is not limited to being applicable to the printer, and is applicable also to facsimiles, copy machines, multi-function peripherals, etc. Further, the present disclosure is applicable also to a liquid droplet ejecting apparatus used for any application other than the recording of an image. For example, the present disclosure is applicable to a liquid droplet ejecting apparatus which forms an electroconductive pattern by ejecting an electroconductive liquid on a substrate.

What is claimed is:

1. A liquid droplet ejecting head comprising:
a pressure chamber disposed along a plane;
a first nozzle which is open in a direction crossing the plane;
a second nozzle which is open in the direction crossing the plane;
a first connecting channel which connects the first nozzle and the pressure chamber; and
a second connecting channel which connects the second nozzle and the pressure chamber,
wherein each of the first connecting channel and the second connecting channel includes a first channel extending in a direction parallel to the plane and a second channel extending in the direction crossing the plane, and
in a case where inertance of a part constructed of the first connecting channel and the first nozzle is M1 [kg/m⁴], and inertance of a part constructed of the second connecting channel and the second nozzle is M2 [kg/m⁴], the liquid droplet ejecting head satisfies the following expression (1):
M1≠M2 Expression (1).

2. The liquid droplet ejecting head according to claim 1, wherein in a case where inertance of the first channel of the first connecting channel is M1a [kg/m⁴], and inertance of the first channel of the second connecting channel is M2a [kg/m⁴], the liquid droplet ejecting head further satisfies the following expression (2):
M1a≠M2a Expression (2).

3. The liquid droplet ejecting head according to claim 2, wherein one end of the first channel is connected to the pressure chamber, and the other end of the first channel is connected to one end of the second channel,
the other end of the second channel is connected to the first nozzle or the second nozzle, and
the one end of the first channel is connected to the pressure chamber, not via a channel extending in the direction crossing the plane.

4. The liquid droplet ejecting head according to claim 2, wherein one end of the first channel is connected to the pressure chamber, and the other end of the first channel is connected to one end of the second channel,
the other end of the second channel is connected to the first nozzle or the second nozzle,
a cross-sectional area of the first channel of the first connecting channel is smaller than a cross-sectional area of the first channel of the second connecting channel,
the first channel of the second connecting channel includes two channel parts which share at least a part, of the first channel, between the one end to the other end, and
resistance of the first channel of the first connecting channel and synthetic resistance of the two channel parts of the second connecting channel are the same.

5. The liquid droplet ejecting head according to claim 4, further comprising a partition wall which divides an area between the one end and the other end of the first channel of the second connecting channel and which is interposed between the two channel parts.

6. The liquid droplet ejecting head according to claim 1, wherein in a case where inertance of the first connecting channel is M1c [kg/m⁴], inertance of the first nozzle is M1n [kg/m⁴], inertance of the second connecting channel is M2c [kg/m⁴], and inertance of the second nozzle is M2n [kg/m⁴], the liquid droplet ejecting head further satisfies the following expression (3) and expression (4):
M1c≤M1n Expression (3)
M2c≤M2n Expression (4).

7. The liquid droplet ejecting head according to claim 1, wherein in a case where primary frequency of the first connecting channel is F1 [KHz], and primary frequency of the second connecting channel is F2 [KHz], the liquid droplet ejecting head further satisfies the following expression (5), expression (6), and expression (7):
F1=F2 Expression(5)
M1≥2.99×10⁴×F1\hat{ }2−1.11×10⁷×F1+1.06×10⁹ Expression (6)
M2≤6.11×10¹×F2\hat{ }3−2.41×10⁴×F2\hat{ }2+1.86×10⁶×F2+1.10×10⁸ Expression (7)

8. The liquid droplet ejecting head according to claim 1, in a case where primary frequency of the first connecting channel is F1 [KHz], and primary frequency of the second connecting channel is F2 [KHz], the liquid droplet ejecting head further satisfies the following expression (8):
F1≠F2 Expression (8).

9. The liquid droplet ejecting head according to claim 8, further satisfying the following expression (9) and expression (10):
M1<2.99×10⁴×F1\hat{ }2−1.11×10⁷×F1+1.06×10⁹ Expression (9)
M2>6.11×10¹×F2\hat{ }3−2.41×10⁴×F2\hat{ }2+1.86×10⁶×F2+1.10×10⁸ Expression (10).

10. The liquid droplet ejecting head according to claim 8, further satisfying the following expression (11) and expression (12):
M1≤−1.23×10⁶×F1+2.32×10⁸ Expression (11)
M2≤−1.23×10⁶×F2+2.32×10⁸ Expression (12)

11. The liquid droplet ejecting head according to claim 10, further satisfying the following expression (13) in a case where F1>F2 and M1>M2 hold:
M1−M2=−1.23×10⁶×(F1−F2) Expression (13).

12. The liquid droplet ejecting head according to claim 1, further comprising a hole having one end communicating with the pressure chamber and the other end communicating with atmosphere, wherein
a meniscus which absorbs pressure variation of liquid in the pressure chamber is formed in the hole.

13. The liquid droplet ejecting head according to claim 1, further comprising:
individual channels each of which includes the pressure chamber, the first nozzle, the second nozzle, the first connecting channel, and the second connecting channel;
a common channel communicating with the individual channels;
a third channel included in each of the individual channels and having one end connected to the pressure chamber and the other end connected to the common channel, the third channel extending in the direction parallel to the plane; and
plates having holes defining the individual channels,
wherein one plate included in the plates has both a hole which defines the first channel and a hole which defines the third channel.

14. The liquid droplet ejecting head according to claim 13, wherein the first channel and the third channel are disposed across entirety of thickness of the one plate.

15. The liquid droplet ejecting head according to claim 2, further comprising:
individual channels each of which includes the pressure chamber, the first nozzle, the second nozzle, the first connecting channel, and the second connecting channel;
a common channel communicating with the individual channels;
a third channel included in each of the individual channels and having one end connected to the pressure chamber and the other end connected to the common channel, the third channel extending in the direction parallel to the plane,
wherein one end of the first channel is connected to the pressure chamber, and the other end of the first channel is connected to one end of the second channel,
the other end of the second channel is connected to the first nozzle or the second nozzle,
M1a>M2a holds, and
a distance, along the plane, between the one end of the first channel of the first connecting channel and the one end of the third channel is smaller than a distance, along the plane, between the one end of the first channel of the second connecting channel and the one end of the third channel.

16. The liquid droplet ejecting head according to claim 1, wherein
the first channel extends in an extending direction parallel to the plane,
the first channel has one end in the extending direction which is connected to the pressure chamber and the other end in the extending direction which is connected to the second channel, and
a position in the extending direction of the other end of the first channel in the first connecting channel coincides with a position in the extending direction of the other end of the first channel in the second connecting channel.
